(19) United States
(12) Patent Application Publication
(10) Pub. No.: US 2002/0082181 A1
(43) Pub. Date: Jun. 27, 2002

(54) Cleaning, laundering or treating compositions containing cross-linked hydrolase crystals

(75) Inventors: Vickie L . Humphrey, Glenoma, WA (US); Kevin L. Stellner, Charlotte, NC (US)

Correspondence Address: Joel J. Hayashida, Corporate Patent Counsel, The Clorox Company, P. O. Box 24305, Oakland, CA, 94623, US

(73) Assignee: THE CLOROX COMPANY

(21) Appl. No.: 10/002,371

(22) Filed: Nov. 15, 2001

Related U.S. Application Data
(63) Continuation of application No. 09/605,045, filed on Jun. 27, 2000, now abandoned.
(60) Provisional application No. 60/141,577, filed on Jun. 29, 1999.

(51) Int. Cl. C11D 3/386; C11D 7/18; C11D 3/00; C11D 9/42

(52) U.S. Cl. 510/305; 510/392; 510/309; 510/306; 510/530

(57) ABSTRACT

The present invention provides a product and method for cleaning or laundering or treatment of fabrics or surfaces, with a liquid cleaning, laundering or treating composition having improved enzyme stability in the presence of an oxidant comprising a) at least one cross-linked hydrolase crystal, or mixture of hydrolase crystals; b) an oxidant, or source of hydrogen peroxide; and c) at least one cleaning, laundering or treating additive, other than an oxidant, wherein the improved stability is due to one or more of the following: (i) where c) includes a surfactant, maintaining the upper limit thereof to no greater than 10% by weight of the composition; (ii) maintaining the pH of the liquid composition between 5 and 8; and (iii) where c) includes surfactants, no more than 20% of the total surfactants is anionic. The use of the cross-linked hydrolase crystals results in compositions which have surprisingly proficient retained hydrolytic stability in the presence of such oxidant versus a commercially available non-cross-linked enzyme.

### RELATED APPLICATIONS

This is a continuation-in-part of Provisional Application No. 60/141,577, Filed Jun. 29, 1999, and incorporated herein by reference.

### FIELD OF THE INVENTION

The present invention generally relates to cleaning or laundering or treatment of fabrics or surfaces with an aqueous liquid cleaning, laundering or treating composition having improved enzyme stability in the presence of an oxidant, comprising a) at least one cross-linked enzyme crystal, or mixture of different types or species of cross-linked enzyme crystals; b) an oxidant, or source of hydrogen peroxide; and c) at least one cleaning, laundering or treating additive, other than an oxidant, wherein the improved stability is due to one or more of the following: (i) where c) includes a surfactant, maintaining the upper limit thereof to no greater than 10% by weight of the composition; (ii) maintaining the pH of the liquid composition between 5 and 8; and (iii) where c) includes surfactants, no more than 20% of the total surfactants is anionic. It is especially preferred that the enzyme be a hydrolase. The cleaning, laundering or treating composition has been demonstrated to have superior retained hydrolytic activity (thus, enduring stability) versus a commercially available enzyme. The cleaning, laundering or treating composition can be executed as various types of liquid compositions, without limitation.

### BACKGROUND OF THE INVENTION

Enzymes, especially hydrolases, are standard additions to both liquid and solid cleaning, treating or laundering compositions. One of the concerns in adding hydrolases to such formulations has been stability (i.e., retaining hydrolytic activity) because of close association in the formulation with materials which may be inimical to stability, such as, without limitation, oxidants, water (moisture), heavy metals, or other materials which may decompose, denature or deactivate hydrolases.

One method of protecting enzymes is to encapsulate them. This is demonstrated in Coyne et al., U.S. Pat. Nos. 4,863,626, 5,093,621, and 5,225,102, and DeLeeuw et al., U.S. Pat. Nos. 5,254,287 and 5,167,854. Another method is to isolate the enzymes, by means of a protective reticulum, or by preventing the premature solubilization of oxidants in a liquid matrix in which the enzymes are suspended, for example, in, respectively, Sells et al., U.S. Pat. No. 5,789,364 and Koerner et al., U.S. Pat. No. 5,589,448, and Peterson et al., U.S. Pat. No. 5,464,552, and WO 91/13963. All of the foregoing patents are incorporated herein by reference.

Van de Pas, WO 91/13963, alleges that a liquid oxidant composition can contain enzymes, and, indeed, even gives some examples in which enzymes were alleged to be incorporated (See page 25, line 22 thereof). However, pointedly, this example does not contain or refer to any evidence of stability of the enzyme in an oxidant system.

Hydrolase activity can subside in the course of storage of the hydrolase within a cleaning or laundering or treatment product, so executing such products to enhance the enzymes' activity is important for good stain removal performance. Examples of this can be seen in Stanislowski et al., U.S. Pat. No. 4,511,490 (synergistic combinations of alkaline proteases), and Stanislowski et al., U.S. Pat. No. 5,364,554 (enzyme-mediated perhydrolysis).

There has previously been work to protect enzymes by crystallizing the enzyme, and then cross-linking the crystal with a multifunctional crosslinking agent. See, Navia et al., U.S. Pat. Nos. 5,849,296 and 5,618,710, and Margolin et al., WO 98/46732, incorporated herein by reference. In fact, it has been determined that these cross-linked enzymes crystals will have enhanced retained activity in a liquid system, such as one containing solvent, or a mixture of solvents, which would ordinarily deactivate the enzymes. See, Chemical & Engineering News, p. 40, 9/28/92, “Cross-Linked Enzyme Crystals Show Promise for Industrial, Clinical Uses,” Genetic Engineering News, December 1992, “Cross-Linked Crystalline Enzymes Offer Promise as Efficient Biocatalysts,” and Altus Biologics Inc.'s website at http://www.altus.com, all of which are incorporated herein by reference.

Moreover, there has heretofore been nothing in the literature which teaches, discloses or suggests that an aqueous liquid cleaning, laundering or treating composition comprising a) at least one cross-linked enzyme crystal, or mixture of enzyme crystals; b) an oxidant, or source of hydrogen peroxide; and c) at least one cleaning, laundering or treating additive, other than an oxidant, will have surprisingly proficient retained hydrolytic stability in the presence of such oxidant versus a commercially available non-cross-linked enzyme, wherein the improved stability is due to one or more of the following: (i) where c) includes a surfactant, maintaining the upper limit thereof to no greater than 10% by weight of the composition; (ii) maintaining the pH of the liquid composition between 5 and 8; and (iii) where c) includes surfactants, no more than 20% of the total surfactants is anionic.

### SUMMARY OF THE INVENTION

The present invention provides a product and method for cleaning or laundering or treatment of fabrics or surfaces, with an aqueous liquid cleaning, laundering or treating composition composition having improved enzyme stability in the presence of an oxidant comprising a) at least one cross-linked enzyme crystal, or mixture of enzyme crystals; b) an oxidant, or source of hydrogen peroxide; and c) at least one cleaning, laundering or treating additive, other than an oxidant, wherein the improved stability is due to one or more of the following: (i) where c) includes a surfactant, maintaining the upper limit thereof to no greater than 10% by weight of the composition; (ii) maintaining the pH of the liquid composition between 5 and 8; and (iii) where c) includes surfactants, no more than 20% of the total surfactants is anionic.

The preferred enzyme used in the compositions and methods of the invention is hydrolase. The cross-linked crystalline hydrolase is most desirably an alkaline protease, which is a particularly preferred and effective hydrolase and has wide ranging applicability for cleaners, laundry products and treatments. However, it is not intended herein to limit the invention to the use of proteases, as there are likely other useful and suitable hydrolases which can be produced in crystal forms, and subsequently cross-linked, such as, without limitation, cutinases, lipases, amylases and cellulases.

When thus formulated, compositions of the invention are useful as or in home or commercial cleaning, laundry and treatment products, such as bleaching additives, detergent boosters, bleaches, bleaching aids, dishwashing detergents, surface and mildew stain removers, spot treatment products such as stain removers, prewash, presoak laundry aids, hard surface and glass cleaners, floor, wall and carpet cleaners, hard and soft surface treatments, including those with preservative or restorative additives.

### DETAILED DESCRIPTION OF THE PREFERRED EMBODIMENTS

The present invention provides a product and method for cleaning or laundering or treatment of fabrics or surfaces, with an aqueous liquid cleaning, laundering or treating composition composition having improved enzyme stability in the presence of an oxidant comprising a) at least one cross-linked enzyme crystal, or mixture of enzyme crystals; b) an oxidant, or source of hydrogen peroxide; and c) at least one cleaning, laundering or treating additive, other than an oxidant, wherein the improved stability is due to one or more of the following: (i) where c) includes a surfactant, maintaining the upper limit thereof to no greater than 10% by weight of the composition; (ii) maintaining the pH of the liquid composition between 5 and 8; and (iii) where c) includes surfactants, no more than 20% of the total surfactants is anionic.

1. Cross-Linked Enzyme Crystals

Enzymes are large proteins which are effective in a variety of industrial and consumer product applications. Of special interest are hydrolases, which act by hydrolyzing specific substrates. Proteases hydrolyze proteins, breaking them down into other intermediates, such as amino acids. Amylases hydrolyze carbohydrates. Lipases hydrolyze lipids, or fats. Cellulases hydrolyze cellulose. Cutinases hydrolyze cutins. There are a wide variety of hydrolases which have been characterized by the International Union of Biochemistry. See, Stanislowski et al., U.S. Pat. No. 4,511,490, incorporated herein by reference.

Scientists at Altus Biologics Inc. (and Vertex Pharmaceuticals) have developed a novel technique for stabilizing enzymes, especially hydrolases, by crystallizing them, and then cross-linking them. The resulting cross-linked enzyme crystal (which they have referred to as “CLEC™”s) has been determined to give the enzyme thus treated good physical durability, while also conferring on the enzyme the ability to withstand relatively harsh environmental conditions, such as temperature, pH, digestion by other proteases, and solvents.

The cross-linked enzyme crystals are produced by first crystallizing the desired enzyme, then reacting the crystal with a chemical cross-linking agent. In WO 98/46732, referred to above, there is a detailed section on the technique for cross-linking, and the cross-linking agent. Examples of such cross-linking agents are depicted in the table of WO 98/46732, from page 35 through page 36, although the specific section on cross-linking on pages 26-47 is specifically incorporated herein by reference. In general, the cross-linking agent is a multifunctional compound that links crystalline proteins into a crystal lattice through covalent bonding between the proteins. These cross-linkers can be homobifunctional or heterobifunctional (meaning that the cross-linking groups could be the same, such as dialdehydes, or different, such as carbamates). In the present invention, the preferred chemical cross-linking agent is one which contains aldehyde groups, which will react with primary amino groups on proteins. The preferred cross-linking agent is glutaraldehyde, which, by having two available aldehyde groups, is considered a bifunctional cross-linking agent, although other reagents having two or more aldehyde groups would be considered suitable for use. In addition, glutaraldehyde is a particularly cost-effective cross-linking agent.

The cross-linked enzyme crystals are especially advantageous in that, generally speaking, the use of calcium or other heavy metal salts are avoided. Soluble calcium salts are typically used to stabilize enzymes. Unfortunately, when such calcium salts are present in formulations where anionic surfactants are introduced, the calcium salts may be leached, or otherwise drawn out of the enzyme and co-precipitated with the anionic surfactant. This undesirable result may have at least two drawbacks: (1) the formation of a residue similar to “soap scum;” and (2) the destabilization of the enzyme.

The use of cross-linked enzyme crystals, especially, hydrolase crystals would be very desirable in the cleaning, laundering and treating products industry. Especially in formulating liquid, oxidant-containing formulations which have typically been problematic in sustaining hydrolytic activity of enzymes added to such formulations. In addition, it is understood that the cross-linked hydrolase crystals have a crystal lattice structure that makes them particularly durable.

The cross-linked hydrolase crystals useful in the compositions and methods of the invention can be formulated with a wide variety of cleaning, laundering or treating additives, including, most desirably, an oxidant. The amount of such cross-linked crystals contained within the liquid oxidant compositions herein can vary greatly, from about 0.001-50% by weight of the liquid, with the upper limit merely circumscribed by the need for a liquid product, and, to a lesser extent, by the cost of including such relatively expensive materials in the liquid product.

Specifically, it has been determined that the crystal structure in the cross-linked enzymes, especially, hydrolases, can be affected by three conditions ordinarily found in cleaning compositions: (1) elevated amounts of surfactant, especially liquid surfactants; (2) pH; and (3) where, again, a surfactant is present, it is preferably to limit the amount of anionic surfactants. Thus, applicants have determined that to resolve these potential destabilizers, it is desirable (1) not to exceed about 10% by weight of the liquid composition of surfactant as a component; (2) to maintain a pH between about 5 to about 8; and (3) where surfactants are present, it is preferred to limit the amount of anionic surfactants present to no more than about 20% of the total surfactants, and it is especially preferred to use blends of one or more nonionic surfactants. Of these potential three solutions, any one , and desirably any combination of two, and potentially all three solutions my be executed to result in the advantageously improved stability compositions of this invention.

2. Oxidants

Oxidants are considered one of the essential ingredients of the compositions. These oxidants include hypochlorite, peroxyacid (or peracid), peroxide or active oxygen source. The peroxide or active oxygen source are especially preferred. Hypochlorites, which are strong oxidants and may be somewhat less preferred, include alkali metal (especially sodium) and alkaline earth (especially calcium) hypochlorites, and other active chlorine sources, such as chlorohydantoins, chlorocyanurates and the like. Peracids are selected from a wide variety of non-limiting examples, including peroxyimdic acid, diperoxyacids (e.g., diperoxydodecanedioic acid), long and short chain alkanoylperacids (e.g., peroctanoic acid) and the like. The peroxide or active oxygen source for compositions of the invention may be selected from most preferably hydrogen peroxide, Caro's acid (peroxymonosulfuric acid), and then, as suspended particulate oxidants, the alkali metal and alkaline metal salts of percarbonate, perborate, persilicate and hydrogen peroxide adducts. Examples of hydrogen peroxide formulations suitable for use herein include those depicted in Mitchell et al., U.S. Pat. No. 4,900,468, Farr et al., U.S. Pat. No. 5,180,514 and Baker et al., U.S. Pat. No. 4,764,302, all of common assignment and all of which are incorporated herein by reference. Where sodium percarbonate, sodium perborate mono- and tetrahydrate, are utilized in aqueous formulations, it is most preferable to suspend them in such aqueous formulations, along with stabilizers. Exemplary of these systems are Peterson et al., U.S. Pat. No. 5,464,552, Published European Patent Applications EP 294 904 and EP 293 040, incorporated herein by reference. Other peroxygen sources may be possible, such as monopersulfates and monoperphosphates, or their equivalent aqueous forms, such as monopersulfuric acid, known in the trade as Caro's acid or Caroate®, a product of BASF AG, Germany; and poorly soluble oxidants, such as alkaline earth peroxides, for example, Gray et al., U.S. Pat. Nos. 4,891,147 and 5,019,189, both of which are incorporated herein by reference. Alternatively, the formulations of the invention may be essentially nonaqueous. These nonaqueous formulations will have a nonaqueous liquid as the continuous phase, such as nonionic surfactant, or nonaqueous organic solvents such as glycol ethers, hydrocarbons, acids, alcohols, and the like. Exemplary nonaqueous formulations are depicted in Peterson et al., U.S. Pat. No. 4,874,537, and Van Buskirk et al., U.S. Pat. No. 5,415,796, both of which are incorporated herein by reference. Additionally, an appropriate bleach activator for the active oxygen source or peroxide may be present, such those found in Arbogast et al., U.S. Pat. Nos. 5,739,327 and 5,741,437, Alvarez et al., U.S. Pat. No. 5,814,242, Deline et al., U.S. Pat. No. 5,877,315 and Casella et al., U.S. Pat. No. 5,888,419 (which relate to cyanonitrile derivatives), Fong et al., U.S. Pat. Nos. 4,959,187 and 4,778,816, Bolkan et al., U.S. Pat. Nos. 5,112,514 and 5,002,691, and Brodbeck et al., U.S. Pat. No. 5,269,962 (which relate to alkanoyloxyacetyl derivatives); and Mitchell et al., U.S. Pat. Nos. 5,234,616, 5,130,045 and 5,130,044 (all of which relate to alkanoyloxyphenylsulfonates), all of which are incorporated herein by reference. The oxidant may be present in an amount ranging from about 0.001-50% of the composition. Preferably, it can range from about 0.05-25% of the composition, and most preferably, between about 0.05-15%.

A large number of cleaning, laundering or treating additives is depicted below.

3. Cleaning, Laundering or Treating Additives

Surfactants which may be used in the inventive compositions include linear ethoxylated alcohols, such as those sold by Shell Chemical Company under the brand name Neodol. Other suitable nonionic surfactants can include other linear ethoxylated alcohols with an average length of 6 to 16 carbon atoms and averaging about 2 to 20 moles of ethylene oxide per mole of alcohol; linear and branched, primary and secondary ethoxylated, propoxylated alcohols with an average length of about 6 to 16 carbon atoms and averaging 0-10 moles of ethylene oxide and about 1 to 10 moles of propylene oxide per mole of alcohol; linear and branched alkylphenoxy (polyethoxy) alcohols, otherwise known as ethoxylated alkylphenols, with an average chain length of 8 to 16 carbon atoms and averaging 1.5 to 30 moles of ethylene oxide per mole of alcohol; and mixtures thereof. Shell Chemical, Huntsman Chemical and Union Carbide are among the numerous producers of these surfactants. As noted above, it is especially preferred to use nonionic surfactants as the adjunct, and, in certain instances, a blend of the nonionics is especially preferred.

Further suitable nonionic surfactants may include polyoxyethylene carboxylic acid esters, fatty acid glycerol esters, fatty acid and ethoxylated fatty acid alkanolamides, certain block copolymers of propylene oxide and ethylene oxide, and block polymers or propylene oxide and ethylene oxide with propoxylated ethylene diamine. Also included are such semi-polar nonionic surfactants like amine oxides (such as Ammnonyx from Stepan and Barlox from Lonza), phosphine oxides, sulfoxides and their ethoxylated derivatives.

Anionic surfactants may also be sparingly suitable. Examples of such anionic surfactants may include the ammonium, substituted ammonium (e.g., mono-di-, and triethanolammonium), alkali metal and alkaline earth metal salts of C₆-C₂₀ fatty acids and rosin acids, linear and branched alkyl benzene sulfonates, alkyl sulfates, alkyl ether sulfates, alkane sulfonates, alpha olefin sulfonates, hydroxyalkane sulfonates, fatty acid monoglyceride sulfates, alkyl glyceryl ether sulfates, acyl sarcosinates and acyl N-methyltaurides. The data which follows suggests that it is preferable to limit the anionic surfactant to some discrete amount, preferably no more than 20% of the total surfactants. As also mentioned hereinabove, it is preferable to limit the total amount of surfactants to no more than 10% of the liquid composition.

Suitable cationic surfactants may include the quaternary ammonium compounds in which typically one of the groups linked to the nitrogen atom is a C₁₂-C₈ alkyl group and the other three groups are short chained alkyl groups which may bear inert substituents such as phenyl groups.

Suitable amphoteric and zwitterionic surfactants containing an anionic water solubilizing group, a cationic group or a hydrophobic organic group include amino carboxylic acids and their salts, amino dicarboxylic acids and their salts, alkyl-betaines, alkyl aminopropylbetaines, sulfobetaines, alkyl imidazolinium derivatives, certain quaternary ammonium compounds, certain quaternary phosphonium compounds and certain tertiary sulfonium compounds.

These and other types of surfactants are exemplified in McCutcheon's Emulsifiers and Detergents (1994) and Kirk-Othmer Encyclopedia of Chemical Technology 3rd, Vol. 22, “Surfactants,” pp. 332-432 (1983), both of which are incorporated herein by reference. The surfactants may be present in the liquid composition from 0.001-10% total surfactants, with the criterion being that a liquid results. As previously indicated, if anionic surfactants are present, they are preferably limited themselves to constituting no more than 20% of the total surfactants within the liquid composition.

When the composition is ready for use as a laundry additive, it is especially advantageous to have an amount of buffer present sufficient to maintain a pH greater than about 4.0, more preferably in the range of about 5 to about 8 for greatest enzyme stability, when the liquid formulation is dispensed into an aqueous wash system. It is further yet more preferred to maintain pH between 6 and 7 for most optimal retained enzyme stability. These are some of the findings of the invention. As for most efficacious bleaching pH, a more alkaline pH has been determined to be desirable, although the trade-off is reduced enzyme stability. As a hard surface cleaner, on the other hand, it may be useful to co-dispense a buffer in a separate, preferably liquid, composition. These buffers include, but are not limited to, alkali metal hydroxides (sodium, lithium, potassium), ammonium hydroxide, alkali metal ortho-, meta- and pyrophosphates, alkali metal silicates, alkali metal tetraborates (penta- and decahydrates), alkali metal and ammonium carbonates, alkali metal and ammonium carbamates (See Garabedian, Jr., et al., U.S. Pat. Nos. 5,523,024, 5,468,423, 5,437,807 and 5,252,245, all incorporated herein by reference), alkali metal and ammonium polyacrylates, alkali metal and ammonium succinates, alkali metal and ammonium maleates and additional conjugate bases of weak organic acids, such as those mentioned hereinabove. Further, organic bases are included, such as, without limitation, ethanolamine, diethanolamine, triethanolamine, hydroxyamine, methylamine, dimethylamine and trimethylamine. Acidic buffers can include citric, acetic, formic, propionic, tartaric, glycolic, and other organic acids, include mixtures thereof, while inorganic acids include sulfamic, sulphuric, sulphurous, phosphoric, hydrochloric, and other inorganic acids, including mixtures thereof. Further, acidic hard surface cleaners are certainly well known and preferred for use as bathroom cleaners. In each execution, care must be taken that the enzyme crystals are in an environment, preferably between pH 5-8, which will optimize their stability. As also mentioned hereinbefore, the buffer, or other pH modifying agent, can be co-delivered if need be.

Other additives or adjuncts (useful in cleaning and laundering applications) may be optionally included in the inventive compositions. Dyes include anthraquinone and similar blue dyes. Pigments may also be used. Monastral colorants are also possible for inclusion. Brighteners or whiteners, such as stilbene, styrene and styrylnaphthalene brighteners (fluorescent whitening agents), may be included. Fragrances used for aesthetic purposes are commercially available from Quest, Sozio, Firmenich, Dragoco, Bush Boake and Allen, Norda, International Flavors and Fragrances and Givaudon. Stabilizers include hydrated salts, such as magnesium sulfate, and boric acid.

Further appropriate adjuvants include a chelating agent or sequestrant, most preferably, an aminopolyphosphonate, to act as oxidant stabilizers. These chelating agents assist in maintaining the solution stability of the salt activators and active oxygen source in order to achieve optimum performance. In this manner, they are acting to chelate heavy metal ions, which can mediate catalyzed decomposition of oxidants, if included. The chelating agent is selected from a number of known agents which are effective at chelating heavy metal ions. The chelating agent should be resistant to hydrolysis and rapid oxidation by oxidants. Preferably, it should have an acid dissociation constant (pKa) of about 1-9, indicating that it dissociates at low pH's to enhance binding to metal cations. Acceptable amounts of the (optional) chelating agent range from 0-1,000, more preferably 5-500, most preferably 10-100 ppm chelating agent, in the wash liquor. As a hard surface cleaner, however, it is preferred to add amounts of the chelating agent form 0-100,000, more preferably 5-50,000, and most preferably 10-10,000 ppm chelating agent. A most preferred chelating agent is an aminopolyphosphonate, which is commercially available under the trademark Dequest from Monsanto Company. Examples thereof are Dequest 2000, 2041 and 2060. (See also Bossu U.S. Pat. No. 4,473,507, column 12, line 63 through column 13, line 22, incorporated herein by reference.) A polyphosphonate, such as Dequest 2010, is also suitable for use. Other chelating agents, such as ethylenediaminetetraacetic acid (EDTA) (See, for example, Robbins et al., U.S. Pat. No. 5,972,876, Chang et al., U.S. Pat. No. 5,948,742, Ochomogo et al., U.S. Pat. No. 5,948,741, and Mills et al., U.S. Pat. No. 5,814,591, all of which are incorporated herein by reference) and nitrilotriacetic acid (NTA) may also be suitable for use. Still other new, preferred chelating agents are new propylenediaminetetraacetates, such as Hampshire 1,3-PDTA, from W. R. Grace, and Chel DTPA 100#F, from Ciba Geigy A.G. Mixtures of the foregoing may be suitable.

Additional desirable adjuncts are yet other, non-crosslinked/non-crystallized enzymes (although it may be preferred to also include an enzyme stabilizer). Non-cross-linked/non-crystallized proteases are one especially preferred class of enzymes. They are preferably selected from alkaline proteases. The term “alkaline,” refers to the pH at which the enzymes' activity is optimal. Alkaline proteases are available from a wide variety of sources, and are typically produced from various microorganism (e.g., Bacillus subtilisis). Typical examples of alkaline proteases include Alcalase, Savinase, and Esperase, all available from Novo Nordisk A/S. See also Stanislowski et al., U.S. Pat. No. 4,511,490, incorporated herein by reference. Further suitable enzymes are amylases, which are carbohydrate-hydrolyzing enzymes. It is also preferred to include mixtures of amylases and proteases. Still other suitable enzymes are cellulases, such as those described in Tai, U.S. Pat. No. 4,479,881, Murata et al., U.S. Pat. No. 4,443,355, Barbesgaard et al., U.S. Pat. No. 4,435,307, and Ohya et al., U.S. Pat. No. 3,983,082, incorporated herein by reference. Yet other suitable enzymes are lipases, such as those described in Silver, U.S. Pat. No. 3,950,277, Thom et al., U.S. Pat. No. 4,707,29.1, and Wiersema et al., U.S. Pat. Nos. 5,296,161 and 5,030,240, and Poulose et al., U.S. Pat. No. 5,108,457, incorporated herein by reference. The additional hydrolytic enzyme should be present in an amount of about 0.01-5%, more preferably about 0.01-3%, and most preferably about 0.1-2% by weight of the detergent. Mixtures of any of the foregoing hydrolases are desirable, especially protease/amylase blends.

Some of the adjuncts, such as the fluorescent whitening agents, enzymes and pigments, are sensitive to oxidants, and thus, may need to be co-dispensed in a separate liquid formulation. On the other hand, there are encapsulation methods and other protective additives available for these sensitive materials, such as, for example, from Coyne et al., U.S. Pat. Nos. 4,863,626, 5,093,021, and 5,225,102 and DeLeeuw et al., U.S. Pat. Nos. 5,254,287 and 5,167,854, incorporated herein by reference.

In some of the embodiments of this invention, there may be a need for a viscosity/phase modifier. Exemplary such materials include alkanolamines, especially triethanolamine, and a wide variety of polymers, including water soluble to water-miscible polymers, such as polyethylene gycol, polyvinyl alcohol, polyvinyl acetate, polyacrylic acid, co-polymers of acrylic acid, co-polymers of methacrylic acid, and the salts thereof. Other polymers include starch, xanthan gum, gum arabic and other naturally occurring polymers. Nonaqueous systems, on the other hand, can be thickened with silicas, such as xerogels and fumed and precipitated silicas, such as Cab-O-Sil.

Anti-redeposition agents, such as carboxy methylcellulose, are potentially desirable. Foam boosters, such as appropriate anionic surfactants, may be appropriate for inclusion herein. Also, in the case of excess foaming resulting from the use of certain surfactants, anti-foaming agents, such as alkylated polysiloxanes, e.g. dimethylpolysiloxane, would be desirable.

In certain hard surface cleaners, it is desirable to incorporate a source of particulate matter to act as abrasives. Abrasives are desirable adjuncts for cleaning especially persistent stains. Abrasives can be selected from a wide variety of particulate materials, including, but not limited to, calcium carbonate, glass beads, polymer beads, perlite, silica sand and various other insoluble, inorganic particulate abrasives are also possible, such as quartz, pumice, feldspar, tripoli and calcium phosphate. See Brodbeck et al., U.S. Pat. No. 5,529,711, and Choy et al., U.S. Pat. Nos. 5,554,321 and 5,470,499, all of which are incorporated herein by reference. Other types of abrasives include water soluble materials present in an amount such as to exceed their solubility in water, leaving a portion thereof undissolved. These types of materials include alkali metal bicarbonates, alkali metal phosphates, alkali metal borates, particularly sodium tetraborate decahydrate (borax) and pentahydrate (see Garner et al., U.S. Pat. No. 6,037,316, incorporated herein by reference.).

4. Delivery Systems

The liquid compositions of the invention can take numerous desirable forms. For example, without limitation, these include macroemulsions, microemulsions, structured liquids, liquid crystals, vesicular systems, lamellar systems, suspensions, dispersions, gels, mulls and pastes. These liquid systems can be clear or translucent (such as microemulsions) to opaque. These liquid systems can either be cleaning liquids, bleaching liquids, as well as detergents and detergent bleaches. They can also be either unitary systems, or multiple deliveries, such as, for example, a dual chamber container, one chamber containing, optionally, a source of active oxygen, while the other contains a solution including actives sensitive to oxidation, for example, the non-cross-linked/non-crystallized enzymes and fluorescent whitening agents. An example of a container which can co-dispense these two different liquid compositions is found in Beacham et al., U.S. Pat. No. 4,585,150, incorporated herein by reference; and an example of a system where a dual delivery is depicted, with one part containing a liquid oxidant formulation, the other, a liquid with materials which are sensitive to oxidation, is found in Choy et al., U.S. Pat. No. 5,767,055,incorporated hereinby reference. In the case of more viscous forms, such as gels, mulls or pastes, the continuous phase can be nonionic surfactants, and is exemplified by Kaufmann et al., U.S. Pat. Nos. 4,743,394 and 5,362,413,both of which are incorporated herein by reference.

5. Fillers for Liquid Medium

For liquids, so that the correct amount of active ingredients are dosed, the inventive compositions may be combined with a liquid medium, most preferably, an inert, nonreactive liquid. Generally speaking, this nonreactive liquid is principally water, or water combined with solvents, or nonaqueous solvents. For bench scale experiments, it is preferred to use deionized water, although in the large scale manufacture of the inventive liquid compositions, this may not be necessary. The solvents can be chosen from any organic or inorganic solvents. Some preferred organic solvents are those with a vapor pressure of at least 0.001 mm Hg at 25° C. and soluble to the extent of at least 1 g/100 ml water. The organic solvents used in the invention are preferably selected from C₁₋₆ alkanol, C₃₋₂₄ alkylene glycol ether, and mixtures thereof. However, other, less water soluble or dispersible organic solvents may also be utilized. The alkanol can be selected from methanol, ethanol, n-propanol, isopropanol, butanol, pentanol, hexanol, their various positional isomers, and mixtures of the foregoing. It may also be possible to utilize in addition to, or in place of, said alkanols, the diols such as methylene, ethylene, propylene and butylene glycols, and mixtures thereof. Other solvents, such as amines, ketones, ethers, esters, carboxylic acids, oils, hydrocarbons and halides may be used alone, or mixtures thereof. In the case of certain amines, e.g., monoethanolamine, diethanolamine, etc., such solvents are also considered buffers. Thus, it is possible that, in certain instances, these amines can be bifunctional herein. Other examples of solvents can be found in Kirk-Othmer, Encyclopedia of Chemical Technology 3rd, Vol. 21, pp. 377-401 (1983), incorporated by reference herein. Where the formulation is a nonaqueous one, liquid nonionic surfactants, as previously mentioned, can be used to provide the continuous phase. Regardless of the liquid depicted, it can constitute anywhere from about 70% to 99.999% of the inventive oxidant composition. Thus, the most preferred compositions herein are aqueous liquid compositions.

6. Applications

a. Laundry Products: Compositions of the invention are useful as or in laundry products, such as bleaching additives, pretreaters or prespotters, detergent boosters, bleaches, bleaching aids, and stain removers.

b. Surface Cleaners: Other product applications include household cleaning products, such as hard surface cleaners to be dissolved in water prior to use. Exemplary surface cleaners are tile and grout cleaners, bathroom (floor, toilet, and counter), kitchen (floor, sink, and counter), and living space (wall, ceiling, floor) cleaners. Additionally, kitchen products such as liquid dishwasher detergents with bleach or bleach, cleaning and impregnated scrubbing pads are contemplated. Spot cleaners and impregnated wipes may also be suitable executions herein. In one preferred embodiment of a hard surface cleaner delivery, as in the laundry product formulation, a dual chambered container/dispenser is preferred. In another preferred embodiment, a single container/dispenser is preferred, taking advantage of the enduring stability of the cross-linked enzyme crystals. Other agents could be included for improved cleaning performance (thickeners, chelating agents, builders, etc.) or aesthetic appeal (dyes, colorants, fragrances). Further, it is common to include in hard surface cleaners at least one solvent to further enhance cleaning performance and to disperse hydrophobic or poorly soluble materials into the liquid cleaner. Fragrances and colorants are also desirable. Buffers selected from the various acids/alkaline materials are desirable, as well as thickening agents which allow the blended liquids to cling to vertical surfaces, such as colloids (clays, alumina, silica) or surfactants, surfactant/solvent mixtures, or polymers.

Additionally, non-household product applications are contemplated. Illustrative of such applications are pool and spa additives, as well as cleaners to remove stains on outdoor concrete, stucco, siding, wood and plastic surfaces. In the food industry, cleaning of surfaces contaminated with food products, and cleaning of piping or conduits conveying liquid foods or ingredients can be done with the inventive cleaners. In laundry products, the liquid product is desirable to prespot or target stains on soiled fabrics and garments.

Aspects of the invention will now be illustrated by the following examples. It will be understood that these examples are intended to illustrate, and not to limit, the invention.

### EXPERIMENTAL

### EXAMPLE 1

Savinase enzyme (Novo Nordisk A/S, Bagsvaerd, Denmark) was obtained and suitable quantities were used in the following three samples: (1) An enzyme sample consisting of prilled enzyme; (2) An enzyme sample in which the enzyme was crystallized; and (3) An enzyme sample in which the enzyme was crystallized and cross-linked with a cross-linking agent, as described hereinabove from page 4, lines 16-30, and incorporated herein by reference.

Each of the samples were then placed in a liquid, aqueous cleaning formulation containing 3.5% hydrogen peroxide and other additives, to determine sustained hydrolytic stability (using known techniques). The stabilities were determined, after 42 days, at room temperature (21° C.), as follows:

TABLE I

| | | % Remaining Activity @ 42 |
|---|---|---|
| Sample | Enzyme | Days |
| 1 | Savinase | 0.00 |
| 2 | Crystal Form | 12.40 |
| 3 | Cross-linked Crystal Form | 39.50 |

### EXAMPLES 2-5

The following examples depict liquid oxidant formulations into which the cross-linked enzyme crystals as prepared in Example I were tested for stability. The various formulations were either a mixture of nonionic/anionic surfactants (Examples 2-3) or nonionic blends (Examples 4-5). In the Examples, footnotes identify some ingredients or provide other information. Where the footnoted material has once been cited, it is not repeated in any of the further Examples, unless necessary for clarity.

### EXAMPLE 2

Low Foaming 80/20 Nonionic/Anionic

| Ingredient | Weight % |
|---|---|
| Water | q.s. |
| Sodium Sulfate | 1.5 |
| Fluorescent Whitener | 0.144 |
| Nonionic Surfactant¹ | 4.98 |
| Antioxidant² | 0.015 |
| NaOH | 0.125 |
| ³Chelating Agent | 0.11 |
| Anionic Surfactant⁴ | 1.28 |
| Hydrogen Peroxide⁵ | 10 |
| Dye | 0.0015 |
| Fragrance | 0.09 |
| Total | 100.000 |

¹Tergitol 15-S-5
²Butylhydroxytoluene
³Polyphosphonate
⁴Tridecylbenzenesulfonic Acid
⁵3.5% H₂O₂, pH 6
The nonionic and anionic surfactants are in a ratio of 80:20.

### EXAMPLE 3

Low Foaming 90/10 Nonionic/Anionic

| Ingredient | Weight % |
|---|---|
| Water | q.s. |
| Sodium Sulfate | 1.5 |
| Fluorescent Whitener | 0.144 |
| Nonionic Surfactant¹ | 5.4 |
| Antioxidant² | 0.015 |
| NaOH | 0.125 |
| ³Chelating Agent | 0.11 |
| Anionic Surfactant⁴ | 0.62 |
| Hydrogen Peroxide⁶ | 8.57 |
| Dye | 0.0015 |
| Fragrance | 0.09 |
| Total | 100.000 |

⁶3% H₂O₂, pH 6
The nonionic and anionic surfactants are in a ratio of 90:10.

### EXAMPLE 4

90/10 Nonionic/Nonionic

| Ingredient | Weight % |
|---|---|
| Water | q.s. |
| Sodium Sulfate | 1.5 |
| Fluorescent Whitener | 0.144 |
| Nonionic Surfactant¹ | 5.4 |
| Antioxidant² | 0.015 |
| NaOH | 0.125 |
| ³Chelating Agent | 0.11 |
| Nonionic Surfactant⁷ | 0.6 |
| Hydrogen Peroxide⁶ | 8.57 |
| Dye | 0.0015 |
| Fragrance | 0.09 |
| Total | 100.000 |

⁷Tergitol Minfoam 1X
The nonionic surfactants are in a ratio of 90:10.

### EXAMPLE 5

77.8/22.2 Nonionic/Nonionic

| Ingredient | Weight % |
|---|---|
| Water | q.s. |
| Sodium Sulfate | 1.5 |
| Fluorescent Whitener | 0.144 |
| Nonionic Surfactant¹ | 4.67 |
| Antioxidant² | 0.015 |
| NaOH | 0.125 |
| ³Chelating Agent | 0.11 |
| Nonionic Surfactant⁸ | 1.33 |
| Hydrogen Peroxide⁶ | 8.57 |
| Dye | 0.0015 |
| Fragrance | 0.09 |
| Total | 100.000 |

⁸Tergitol 15-S-7
The nonionic surfactants are in a ratio of 77.8:22.2.

The following enzymes were tested in these liquid matrices for enzyme stability (retained enzyme activity). A, Savinase, is a Control, uncrosslinked alkaline protease, available from Novo Nordisk A/S. The remaining enzymes which were crosslinked were proprietary alkaline proteases similar in character to Savinase.

TABLE II

| Enzyme | | Weight % |
|---|---|---|
| A. | Savinase (Control; uncrosslinked) | 1% |
| B. | S/S1 (lightly crosslinked) | .08% |
| C. | S/S17 (heavily crosslinked) | .08% |
| D. | S/A1 (lightly crosslinked) | .08% |
| E. | S/A17 (heavily crosslinked) | .08% |
| F. | S/S (lightly crosslinked) | .08% |
| G. | E/A1 (lightly crosslinked) | .08% |
| H. | E/A17 (heavily crosslinked) | .08% |

The enzymes of TABLE II were tested in the liquid oxidant compositions of Examples 2-5 for stability via a modified ELISA test. The results are tabulated below, in TABLE III:

TABLE III
Enzyme Stability in Liquid Oxidant Formulations

| | | Moderate | | |
|---|---|---|---|---|
| | Highly | to High | Moderately | |
| | Stable | Stability | Stable | Unstable |
| | (≧90% of | (60-90% | (20-60% | (≦20% |
| Liquid | protein | protein | protein | protein |
| Oxidant | remaining at | remaining at | remaining at | remaining at |
| Formulation | T = 6 wks) | T = 6 wks) | T = 6 wks) | T = 6 wks) |
| 2 | C, E, G, H | D | B | A, F |
| 3 | C | D, G | B, E, F | A |
| 4 | B, C, D, E | | F | A |
| 5 | C, F, G, H | D, E | B | A |

From TABLE III, it can be seen that an uncrosslinked enzyme (Example A, Savinase, from Novo Nordisk A/S), which represents a Control, was not stable in a liquid oxidant composition over a 6 week period. Contrast that to the invention, portrayed in Examples B 20 through H, which retain generally high stability over a 6 week period, although Example F was found to be unstable in Formulation 2, which had a high level of anionic surfactant. This thus demonstrates that an all nonionic surfactant formulation is probably preferred, although the crosslinked enzymes, in general, performed unexpectedly superiorly to an uncrosslinked enzyme.

In the next set of Examples, the performance of non-crosslinked enzymes versus crosslinked enzymes were compared on a test stain, namely, grass.

### EXAMPLE 6

### Grass Stain Preparation

Cotton swatches (also called flags) were prepared and stained with a proprietary liquid grass solution. The grass solution is to emulate a real grass stain upon fabric. This is an especially resistant and problematic stain for laundry products to overcome. One set of flags was stained once (1× Grass), the other stained with a liquid grass preparation containing twice the active amount of the previous preparation (2× Grass). The flags were then tested for grass stain removal via a proprietary automated calorimetric reader.

### EXAMPLES 7-16

### Laundry Performance

The flags were then tested by washing, in standard 69 liter capacity automatic washing machines, to which various cleaning products were added. The standard cleaning product is a fabricated detergent called AATCC (which is prepared without enzyme and is representative of a typical commercial laundry detergent), which was used alone in Examples 7 and 12. In Examples 10-11 and 15-16, a quantity of cross-linked enzymes were added to the AATCC detergent. In comparison examples 8 and 13, a commercially available hydrogen peroxide based bleach called Vivid (S.C. Johnson & Son) was also tested for percent grass stain removal. Comparison Examples 9 and 14 show an uncrosslinked enzyme's performance. The results are tabulated in TABLE IV:

TABLE IV

| | | |
|---|---|---|
| | Example/ | Example/ |
| Treatment | 1X Grass Stain | 2X Grass Stain |

| | | | | |
|---|---|---|---|---|
| AATCC Detergent | 7. | 39.96% | 12. | 32.2% |
| Vivid | 8. | 53.19% | 13. | 34.68% |
| Uncrosslinked Enzyme | 9. | 97.4% | 14. | 79.42% |
| Light Crosslinked Enzyme | 10. | 93.76% | 15. | 76.65% |
| Heavy Crosslinked Enzyme | 11. | 76.6% | 16. | 53.45% |

These data demonstrate that the crosslinked enzymes, in addition to having superior stability to uncrosslinked enzymes, will also have very capable performances in the compositions and methods of the invention. In the case of lightly crosslinked enzymes, the performance is on parity with uncrosslinked enzymes. In the case of heavily crosslinked enzymes, the performance is unexpectedly good. In both cases (10-11 and 15-16), the crosslinked enzymes outperformed the control AATCC detergent and the commercial product Vivid.

### EXAMPLES 17-27

### Pretreatment Performance

In this set of Examples, the performances of the enzymes when used as a pretreatment on the flags (i.e., to emulate a prespotter) was observed. In these examples, the flags were, when the enzymes were added, treated with a milliliter solution on the flags for five minutes (Examples 21 -22 and 26-27 for the cross-linked enzymes; 19 and 25 for the uncrosslinked enzymes). Thereafter, the flags were laundered with the AATCC detergent. Comparisons were also made with AATCC detergent alone in Examples 17 and 23 and with Vivid (in the presence of AATCC detergent) in Examples 18 and 24. The results are tabulated in TABLE V:

TABLE V

| | Example/ | | Example/ | |
|---|---|---|---|---|
| Treatment | 1X Grass Stain | | 2X Grass Stain | |
| AATCC Detergent | 17. | 39.96% | 23. | 32.2% |
| Vivid | 18. | 83.33% | 24. | 58.78% |
| Uncrosslinked Enzyme | 19. | 97.4% | 25. | 87.16% |
| Light Crosslinked Enzyme | 21. | 97.66% | 26. | 86.94% |
| Heavy Crosslinked Enzyme | 22. | 97.58% | 27. | 85.78% |

These data demonstrate that the crosslinked enzymes, in addition to having superior stability to uncrosslinked enzymes, will also have very capable performances in the compositions and methods of the invention. In the case of both lightly and heavily crosslinked enzymes, the performance is on parity with uncrosslinked enzymes.

In a further set of Examples, it is demonstrated why pH, total amount of, and character of, surfactants has an effect on the cross-linked enzymes.

TABLE VI

| Enzyme | | Weight % |
|---|---|---|
| I. | AATCC Detergent (Control) | N/A |
| J. | Proprietary Protease | .08% |
| K. | DA (Not crosslinked) | .08% |
| J.. | DD (lightly crosslinked) | .08% |
| C. | DG (heavily crosslinked) | .08% |

### EXAMPLE 28

### Liquid Oxidant Bleach Compositions

First, sufficient linear alkylbenzenesulfonate surfactant (referred to as “LAS,” anionic) was added to deionized water and buffered to pH 3.5 in two examples. In addition, to two further LAS examples were added sufficient hydrogen peroxide to yield a 3.5% solution. Only the crosslinked enzymes were tested for stability therein.

TABLE VII

| 8% LAS, pH 3.5 | 8% LAS, 3.5% peroxide |
|---|---|
| J dissolved in 1-3 hours | J dissolved in 4-5 hours |
| K dissolved in 2-4 hours | K dissolved in 5-6 hours |

From this data in TABLE VII, one concludes that exceeding 10% total surfactant is inimical to crosslinked enzyme stability. Further, if the pH is lowered below 4, instability certainly follows.

The effect of pH and blend of surfactants was also assayed over a longer period of time. In this study, once again, 3.5% H₂O₂ solutions were used and crosslinked enzyme Examples J and K tested. Two week stability was assessed by “% remaining” enzyme, as indirectly tested by their remaining activities (this is the reason for some of the data indicated a greater than 100% remaining enzyme). This is demonstrated in TABLE VIII below:

TABLE VIII

| | |
|---|---|
| pH 4 and 7, all Nonionic | Comparison of Anionic vs. |
| Formulation, 2 weeks | Nonionic Formulations, |
| % remaining activity | 2 weeks % remaining activity |

| | | | | |
|---|---|---|---|---|
| J, pH 4 | ˜20% | J, pH 7, | 100% anionic | <10% |
| J, pH 7 | ˜100% | J, pH 7, | nonionic | ˜160% |
| K, pH 4 | ˜95% | K, pH 7, | 100% anionic | ˜40% |
| K, pH 7 | ˜180% | K, pH 7, | 100% nonionic | ˜190% |

This data demonstrates the advantages of, separately, maintaining pH between 5 and 8, especially 7, and limiting the amount of anionic surfactant in the formulation to no more than 20% of the total surfactants.

The invention is further exemplified without limitation of scope or equivalents by the claims which follow hereto.

1. A product for cleaning or laundering or treatment of fabrics or surfaces, said product comprising an aqueous liquid cleaning, laundering or treating composition having improved enzyme stability in the presence of an oxidant which comprises:
a) at least one cross-linked enzyme crystal, or mixture of enzyme crystals;
b) an oxidant, or source of hydrogen peroxide; and
c) at least one cleaning, laundering or treating additive, other than an oxidant, wherein the improved stability is due to one or more of the following: (i) where c) includes a surfactant, maintaining the upper limit thereof to no greater than 10% by weight of the composition; (ii) maintaining the pH of the liquid composition between 5 and 8; and (iii) where c) includes surfactants, no more than 20% of the total surfactants is anionic.

2. The product of claim 1 wherein said enzyme or mixture of enzymes comprises at least one hydrolase.

3. The product of claim 2 wherein said hydrolase is selected from the group consisting of proteases, amylases, esterases, lipases, oxidases, peroxidases, cutinases, cellulases and mixtures thereof

4. The product of claim 1 wherein said oxidant is hydrogen peroxide.

5. The product of claim 1 wherein said cleaning, laundering or treating additive is selected from the group consisting of surfactants, polymers, hydrotropes, builders, chelating agents, antimicrobial compounds, preservatives, colorants, fluorescent whitening agents, fragrances, solvents, further enzymes, further oxidants, bleach activators, stabilizers, abrasives, antioxidants, and mixtures thereof.

6. The product of claim 5 wherein said cleaning, laundering or treating additive comprises a surfactant.

7. The product of claim 6 wherein said surfactant is selected from the group consisting of anionic, nonionic, cationic, amphoteric, zwitterionic surfactants, and mixtures thereof.

8. The product of claim 7 wherein said surfactant is a blend of nonionic surfactants.

9. A method for cleaning or laundering or treatment of a fabric or surface, said method comprising contacting said fabric or surface with an aqueous liquid cleaning, laundering or treating composition having improved enzyme stability in the presence of an oxidant which comprises:
a) at least one cross-linked enzyme crystal, or mixture of enzyme crystals;
b) an oxidant, or source of hydrogen peroxide; and
c) at least one cleaning, laundering or treating additive, other than an oxidant, wherein the improved stability is due to one or more of the following: (i) where c) includes a surfactant, maintaining the upper limit thereof to no greater than 10% by weight of the composition; (ii) maintaining the pH of the liquid composition between 5 and 8; and (iii) where c) includes surfactants, no more than 20% of the total surfactants is anionic.
